(19) United States
(12) Patent Application Publication
(10) Pub. No.: US 2005/0209776 A1
(43) Pub. Date: Sep. 22, 2005

(54) Navigation apparatus and intersection guidance method

(76) Inventor: Takayuki Ogino, Iwaki-city (JP)

Correspondence Address: BRINKS HOFER GILSON & LIONE, P.O. BOX 10395, CHICAGO, IL, 60610, US

(21) Appl. No.: 11/041,526

(22) Filed: Jan. 24, 2005

(30) Foreign Application Priority Data
Jan. 26, 2004 (JP) 2004-017211

(51) Int. Cl. G01C 21/34

(52) U.S. Cl. 701/211; 340/995.2

(57) ABSTRACT

A navigation apparatus and an intersection guidance method are provided for guiding a user through a guidance intersection located on a guidance route in an easy-to-understand manner even when no facility serving as a landmark is located near the guidance intersection, or when facility located near the guidance intersection is difficult to observe. When a user's vehicle is approaching within a specified distance of a guidance intersection on a guidance route, a navigation apparatus mounted in the vehicle obtains information about a traveling position and a traveling direction of another vehicle located near the user's vehicle and characteristics information about the other vehicle through inter-vehicle communication between the vehicles. Then, based on the information, the apparatus provides a guidance message indicating a travel direction of the user's vehicle in relation to the information about the other vehicle. Accordingly, the use of the other vehicle as a landmark can show the user the direction of travel in which the user's vehicle is to travel at the guidance intersection in an easy-to-understand manner.

### BACKGROUND OF THE INVENTION

1. Field of the Invention

The present invention relates to vehicle navigation apparatus and intersection guidance methods using same. More particularly, the invention is directed to an intersection guidance method for guiding a user's vehicle to an intersection near which no conspicuous landmark is located.

2. Description of the Related Art

Generally, vehicle navigation apparatus are designed to guide a traveling vehicle, thereby allowing a driver to easily reach a desired destination. In such navigation apparatus, a present position of the vehicle is detected using an autonomous navigation sensor, a global positioning system (GPS) receiver, or the like. Map data of the present vehicle position and its surroundings are read from a recording medium, such as a DVD-ROM or a hard disk, and are displayed on a screen. As the vehicle travels, that is, as a present traveling position of the vehicle is changed, a vehicle position mark indicative of the vehicle position is moved on the screen, or otherwise the map of the surrounding area is scrolled with the vehicle position mark fixed at a predetermined position on the screen, thus allowing a user to understand the present traveling position of the vehicle at a glance.

Most of the recent navigation apparatus have a function of route guidance that enables the driver to easily travel along an appropriate route to the desired destination without taking a wrong path. This route guidance function automatically searches for a route with the smallest cost connecting a starting point to the destination using the map data. The resultant route searched for is displayed as a guidance route on a map screen by drawing a thick line in a color different from that of any other road.

It should be noted that the term “destination” includes not only the destination finally intended by the driver, but also a transit point located between the present vehicle position and the destination. The aforesaid cost may be set in terms of a value obtained from multiplying a distance along a road by a predetermined constant corresponding to the width of the road, the type of the road (general road, highway, or the like), the direction of a turn, namely, a right turn or left turn, or traffic regulation. Thus, the cost is a numeric value indicating the degree of propriety as the guidance route. Even two roads with the same distance may differ from each other in cost depending on a searching condition designated, for example, whether the driver intends to make use of a highway or not, or whether the driver gives a higher priority to the time or the distance. In this route search processing, a node is defined by a point where a plurality of roads are interconnected with one another, such as an intersection or a junction point, and a link is defined by a vector connecting adjacent nodes. Links included in various possible routes from the present position to the destination have their costs calculated, and thereafter the cost of all the links in each route are added up in sequence. Thus, the route having the smallest total link cost is selected as the guidance route.

This type of navigation apparatus carries out intersection guidance so as to surely guide the driver to the destination when the vehicle is approaching within a predetermined distance from a guidance intersection on the guidance route. The intersection guidance involves announcing by voice a next direction in which the vehicle is to travel beyond the intersection, or alternatively displaying an enlarged view of a guidance image of the intersection together with an arrow indicative of the next direction of travel. More specifically, some navigation apparatus have come into wide use which are designed to display to a user a facility selected as a landmark from among various facilities located near the intersection and to provide voice guidance including the name of the facility, thereby providing easy-to-understand intersection guidance. (For example, “Please turn right after 300 m. ∘∘ Bank is the landmark.”)

A navigation technique has been proposed that, when a plurality of facilities serving as landmarks are located near or in the vicinity of the intersection, priorities are assigned to these facilities and the voice guidance relating to the facilities is provided in order of priority, as disclosed in JP-A-2002-39779, for example.

The known navigation apparatus including that disclosed in the aforesaid Patent Publication can provide voice guidance using a landmark when a facility serving as the landmark is located near the guidance intersection on the guidance route. The apparatus, however, cannot provide voice guidance by the use of a landmark when no facility serving as a landmark is located near the guidance intersection on the route. In addition, even if there is a facility serving as a landmark located near the guidance intersection on the route, this facility may be difficult to observe from the vehicle equipped with the navigation apparatus because of its location. In this case, the user has difficulty in identifying the intersection on the guidance route at the scene.

### SUMMARY OF THE INVENTION

The present invention has been accomplished in view of the foregoing problems encountered with the prior art, and it is an object of the invention to make it possible to guide a user to an intersection located on a guidance route in an easy-to-understand manner even when no facility serving as a landmark is located near the intersection on the route, or even when the facility serving as the landmark is difficult to observe from a vehicle equipped with a navigation apparatus because of its location.

In order to solve those prior art problems, according to one aspect of the present invention, there is provided a vehicle navigation apparatus that is adapted to determine whether or not a predetermined condition is satisfied based on information obtained from another vehicle located in the vicinity of a user's vehicle when the user's vehicle is approaching within a specified distance of a guidance intersection on a guidance route, and to announce a guidance message indicating a direction in which the user's vehicle is to travel in relationship to the information regarding the other vehicle when the predetermined condition is satisfied. Further, the information regarding the other vehicle is obtained through inter-vehicle communication with the other vehicle. Alternatively, information regarding the other vehicle may be obtained by photographing the other vehicle.

According to another aspect of the invention, the obtained information regarding the other vehicle includes information about the characteristics of the other vehicle, and information about a traveling position and traveling direction thereof. When the other vehicle is determined to be approaching within a predetermined distance of the guidance intersection based on the information about the traveling position and direction thereof, a guidance message including the characteristics of the other vehicle is provided.

With the above-mentioned arrangement, according to the invention, another vehicle approaching the guidance intersection for the user's vehicle is used as a landmark to carry out intersection guidance. Even when no facility serving as a landmark is located near the guidance intersection, or even when a facility serving as a landmark is difficult to see because of its location, the apparatus can provide positional information about the guidance intersection on a guidance route to the user in an easy-to-understand manner. Accordingly, this permits the user to travel the guidance route without hesitation and without fail.

### BRIEF DESCRIPTION OF THE DRAWINGS

FIG. 1 is a schematic explanatory diagram of a vehicle equipped with a navigation apparatus according to a first preferred embodiment of the invention;

FIG. 2 is a diagram showing an example of a display screen for intersection guidance;

FIG. 3 is a block diagram showing an example of a configuration of the navigation apparatus according to the first preferred embodiment;

FIG. 4 is a flowchart showing the operation of the navigation apparatus and an intersection guidance method according to the first preferred embodiment;

FIG. 5 is a schematic explanatory diagram of a vehicle equipped with a navigation apparatus according to a second preferred embodiment of the invention;

FIG. 6 is an explanatory diagram showing a method for calculating a distance from the position of a user's own vehicle to an intersection which another vehicle is entering in the navigation apparatus according to the second preferred embodiment;

FIG. 7 is a block diagram showing an example of a configuration of the navigation apparatus according to the second preferred embodiment;

FIG. 8 is a flowchart showing the operation of the navigation apparatus and an intersection guidance method according to the second preferred embodiment; and

FIG. 9 is a schematic explanatory diagram of a vehicle equipped with a navigation apparatus according to a variation.

### DESCRIPTION OF THE PREFERRED EMBODIMENTS

### First Preferred Embodiment

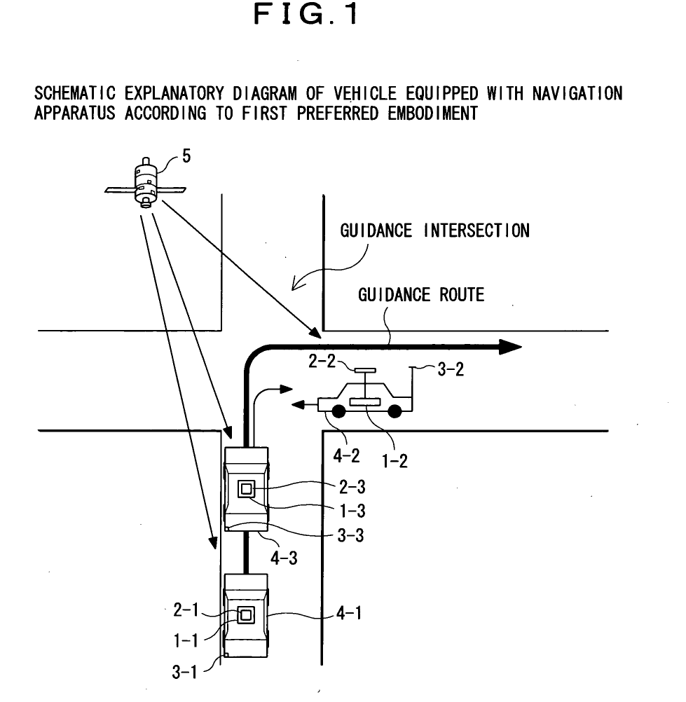

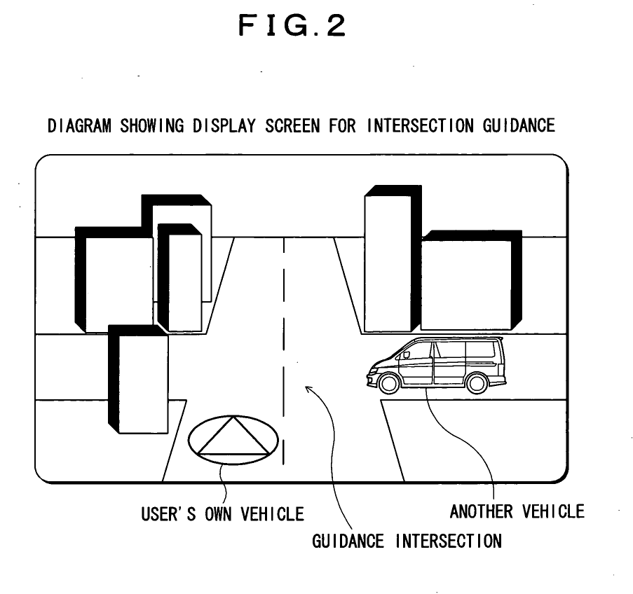

Now, a first preferred embodiment according to the invention will be described hereinafter with reference to the accompanying drawings. FIG. 1 shows a schematic explanatory diagram of a vehicle equipped with a navigation apparatus according to the first preferred embodiment. FIG. 2 shows an example of a navigation screen resulting from intersection guidance according to the first embodiment.

Referring to FIG. 1, a user's own vehicle 4-1 and other vehicles 4-2, 4-3 are equipped with navigation apparatus 1-1 to 1-3, respectively, which employ inter-vehicle communication systems. The navigation apparatus 1-1 to 1-3 include respective GPS antennas 2-1 to 2-3, which receive GPS radio waves transmitted from a GPS satellite 5. A present position of the vehicle (an absolute position expressed in latitude and longitude), moving speed and moving direction thereof, an altitude of the position, and the like (all of which will be hereinafter referred to as “GPS information”) are detected based on GPS signals. The present vehicle position corresponds to information about a traveling position; and the moving direction of the vehicle corresponds to information about a traveling direction as described in the appended claims.

The navigation apparatus 1-1 to 1-3 include respective ground wave antennas 3-1 to 3-3. The user's vehicle 4-1 transmits GPS information about the vehicle 4-1 detected in the above-mentioned manner and prestored profile information about the vehicle 4-1 to the other vehicles 4-2 and 4-3 using the ground wave antenna 3-1. Likewise, the vehicle 4-1 receives GPS information and profile information about the vehicles 4-2 and 4-3 transmitted therefrom using the ground wave antenna 3-1.

The GPS information and profile information about the other vehicles 4-2 and 4-3 corresponds to information regarding another vehicle as described in the appended claims. The GPS information received and transmitted includes information indicating the traveling position and direction of the vehicle, which correspond to information about the traveling position and information about the traveling direction as described in the appended claims. The profile information received and transmitted is information concerning characteristics of the vehicle, including the type, category, and color of the vehicle, which corresponds to characteristics information as described in the appended claims.

The navigation apparatus 1-1 mounted in the user's vehicle 4-1 is operable to read map data corresponding to the present position of the vehicle 4-1 detected by itself from a recording medium and to display it on a screen. A vehicle position mark indicative of the present position of the vehicle 4-1 is displayed on the map screen, while other vehicle position marks indicative of the positions of the other vehicles 4-2 and 4-3 are also displayed based on the GPS and profile information about the vehicles 4-2 and 4-3 received therefrom through the ground wave antenna 3-1.

Specifically, when the user's vehicle 4-1 is provided with a guidance route which recommends the vehicle to turn right with respect to the traveling direction at a guidance intersection located at a predetermined distance (e.g. 50 m) from the present position thereof, the vehicle 4-1 establishes inter-vehicle communications with the other vehicles 4-2 and 4-3 located in the vicinity of the vehicle 4-1. Of these vehicles 4-2 and 4-3 which establish the inter-vehicle communications with the vehicle 4-1, the first other vehicle 4-2 is entering the guidance intersection from a point, which is to be traveled by the vehicle 4-1 after turning right along the guidance route, and located within a predetermined distance from the guidance intersection.

The ground wave antenna 3-1 of the user's vehicle 4-1 receives the GPS and profile information regarding the first other vehicle 4-2 transmitted by a ground wave antenna 3-2 of the other vehicle 4-2. The navigation apparatus 1-1 specifies the characteristics including the type, category (e.g. van, sedan, wagon, or the like), and color of the first other vehicle 4-2, based on the received GPS and profile information about the first other vehicle 4-2, and carries out intersection guidance with the first other vehicle 4-2 set as a landmark.

A method for guiding the user's vehicle to the intersection may involve displaying the vehicle position mark of the first other vehicle 4-2 on the map screen as shown in FIG. 2, or providing voice guidance. For example, when the first other vehicle 4-2 is a white minivan, the situation where the white minivan corresponding to the first other vehicle 4-2 is entering the guidance intersection from the right with respect to the intersection may be displayed on the map screen. Alternatively, or additionally, there may be provided voice guidance, for example, “Please turn right along the way. A white minivan now entering the intersection is a landmark.” or “Please turn right along the way. A white minivan coming into view up ahead is a landmark.”

The second other vehicle 4-3 which establishes inter-vehicle communications with the user's vehicle 4-1 is traveling in front of the vehicle 4-1 and is provided with the same guidance route as that for the vehicle 4-1, which route recommends turning right at the same guidance intersection. Note that information that the second other vehicle 4-3 will turn right at the same intersection as the vehicle 4-1 is obtained from data about the guidance route for the second other vehicle 4-3 (as will be described later).

The ground wave antenna 3-1 of the user's vehicle 4-1 receives the GPS and profile information regarding the second other vehicle 4-3 from the ground wave antenna 3-3 of the second other vehicle 4-3. The navigation apparatus 1-1 of the vehicle 4-1 specifies the characteristics including the type, category (e.g. van, sedan, wagon, or the like), and color of the second other vehicle 4-3, based on the received GPS and profile information about the second other vehicle 4-3, and carries out intersection guidance with the second other vehicle 4-3 set as a landmark.

A method for guiding the user's vehicle to the intersection may involve displaying the vehicle position mark of the second other vehicle 4-3 on the map screen, or providing voice guidance. For example, when the second other vehicle 4-3 is a black sedan, the situation where the black sedan corresponding to the second other vehicle 4-3 is traveling in front of the user's vehicle 4-1 may be displayed on the map screen. Alternatively, or additionally, there may be provided voice guidance, for example, “Please turn right along the way in the same direction as a black sedan.” or “Please turn right along the way, and follow a black sedan traveling in front of your car.” It should be noted that since the second other vehicle 4-3 traveling in front of the vehicle 4-1 may not necessarily turn right along the guidance route, this intersection guidance may be carried out based on suggestions. For example, “Please turn right. A black sedan traveling in front of your car should turn right at the same intersection.”

In these examples, the first and second other vehicles 4-2 and 4-3 act as the landmarks for the intersection guidance. Note that, when both first and second other vehicles 4-2 and 4-3 are simultaneously located near the user's vehicle as shown in FIG. 1, either or both vehicles 4-2 and 4-3 may be selected as the landmark. Alternatively, the first other vehicle 4-2 traveling in the direction opposite to the travel direction of the vehicle 4-1 on the guidance route for the user's vehicle 4-1 may be given higher priority. Otherwise, the second other vehicle 4-3 traveling in front of the vehicle 4-1 in the same direction as the vehicle 4-1 may be given higher priority.

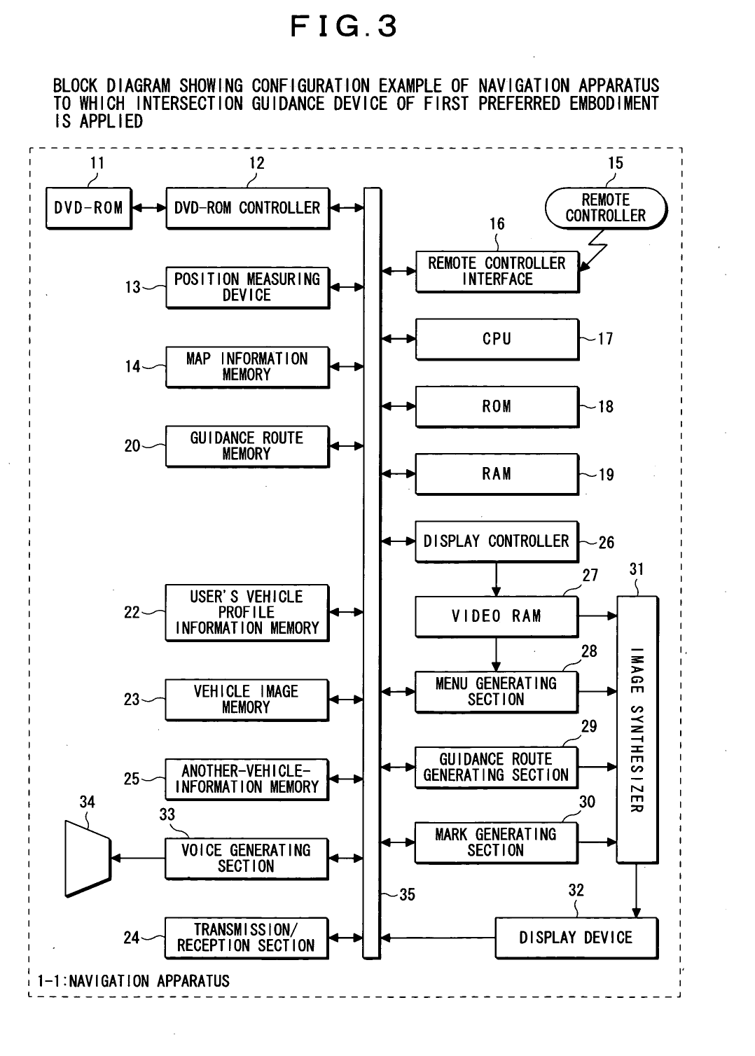

FIG. 3 shows a block diagram of a configuration example of the navigation apparatus 1-1 according to the first preferred embodiment, which is mounted in the user's vehicle 4-1, for example. Note that in the descriptions below, the configuration of the navigation apparatus 1-1 will be taken as an example, but the other navigation apparatus 1-2 and 1-3 for the first and second other vehicles 4-2 and 4-3 have similar configurations.

Referring to FIG. 3, a map recording medium 11 is, for example, a DVD-ROM or the like, and stores therein various kinds of map data necessary for map display, route search, and the like. Note that although in the example the DVD-ROM 11 is used as the recording medium for storing therein the map data, the invention is not limited thereto. Any recording medium, such as a CD-ROM or a hard disk, may be used. A DVD-ROM controller 12 controls reading of the map data from the DVD-ROM 11.

The map data recorded in the DVD-ROM 11 includes a drawing unit consisting of various kinds of data necessary for the map display, a road unit consisting of data necessary for various procedures including map matching, route search, and route guidance, etc., and an intersection unit consisting of detailed data about intersections. The map data further includes three-dimensional data for displaying a three-dimensional map (3D map).

The above-mentioned road unit includes a unit header for identification of the road unit, a connection node table for storing therein detailed data about nodes corresponding to points where a plurality of roads intersect, such as an intersection and a branch point, a node table indicative of a storage position of the connection node table, and a link table for storing therein detailed data about links corresponding to roads or lanes, each link connecting one node located on a road to an adjacent node.

The link table stores therein link records including information on a link ID, a node number, a length of link, a cost of link, a flag indicative of a road attribute, a flag indicative of a road type, and a number of lanes. The link length corresponds to an actually measured length of the road corresponding to the link. The link cost is the time required to travel the link, which is obtained by calculation based on factors such as the type of road or the like, more specifically, the time required to pass through the link, for example, expressed in minutes.

A position measuring device 13 is provided for measuring a present position of the vehicle and includes an autonomous navigation sensor, a GPS receiver, and a CPU for calculation of the position. The autonomous navigation sensor includes a vehicle speed sensor (distance sensor) for detecting a vehicle's moving distance by generating one pulse per a predetermined traveling distance of the vehicle, and an angular speed sensor (relative bearing sensor) such as a vibrating gyro for detecting a rotational angle (moving direction) of the vehicle. The autonomous navigation sensor detects the relative position and direction of the vehicle with the vehicle speed sensor and the angular speed sensor.

The CPU for the position calculation calculates the absolute position (estimated vehicle position) and direction of the user's vehicle 4-1 based on the data concerning the relative position and direction of the vehicle 4-1 provided from the autonomous navigation sensor. The GPS receiver receives radio waves transmitted from a plurality of GPS satellites with the GPS antenna and calculates the absolute position and direction of the vehicle 4-1 by a three-dimensional (3D) or two-dimensional (2D) positioning procedure. (The present vehicle direction is obtained from calculation based on the present position of the vehicle 4-1 and a previous position thereof over a time period of one sampling ΔT.)

A map information memory 14 temporarily stores therein the map data read from the DVD-ROM 11 under control of the DVD-ROM controller 12. That is, the DVD-ROM controller 12 receives information about the present vehicle position from the position measuring device 13 and sends a command to read the map data for an area within a predetermined range from the present vehicle position, so that the map data necessary for the map display and the guidance-route search is read from the DVD-ROM 11 and stored in the map information memory 14.

A remote controller (remote control) 15 includes various operation elements (a button, a joystick, and the like) with which a user sets various kinds of information (e.g., a destination for the route guidance) or performs various operations (e.g., a menu selection operation, a scaling operation, a switching operation between two-dimensional and three-dimensional displays, a manual map scrolling operation, a character input operation, or the like). A remote controller interface 16 receives infrared signals from the remote controller 15 in response to an operational condition.

A processor (CPU) 17 controls the entire navigation apparatus 1-1. The CPU 17 corresponds to control means as described in the appended claims. A ROM 18 stores therein various kinds of programs (such as an inter-vehicle communication program, another-vehicle-extraction program, an intersection guidance program, and a guidance-route search processing program). A RAM 19 temporarily stores therein data obtained during the course of various processes, data resulting from the various processes, and the like. The above-mentioned CPU 17 searches for a guidance route with the smallest cost from the present vehicle position to the destination using the map data stored in the map information memory 14, for example, according to the guidance-route search processing program stored in the ROM 18.

A guidance route memory 20 stores therein data about a guidance route searched for by the CPU 17. The stored guidance route data comprises the position of each node and an intersection identification flag representing whether the node is an intersection or not, for each node located between the starting point and the destination.

A user's vehicle profile information memory 22 stores therein profile information on the user's vehicle 4-1 (including information concerning the type, category, and color of the vehicle). The profile information can be arbitrarily set and registered by operating the remote controller 15. A vehicle image memory 23 prestores therein a plurality of pieces of image data corresponding to various types and colors of vehicles.

A transmission/reception section 24 transmits the GPS information about the user's vehicle 4-1 detected by the position measuring device 13, data about the guidance route stored in the guidance route memory 20, and the profile information about the vehicle 4-1 prestored in the user's vehicle profile information memory 22, to an external device (other vehicles 4-2, 4-3) using the ground wave antenna 3-1. Also, the transmission/reception section 24 receives the GPS information about the other vehicles 4-2 and 4-3 transmitted therefrom, data about the guidance route for these vehicles, and profile information about them through the ground wave antenna 3-1. The transmission/reception section 24 corresponds to another-vehicle-information obtaining means as described in the appended claims. An another-vehicle-information memory 25 stores therein the GPS information, the guidance route data, and the profile information concerning the other vehicles 4-2 and 4-3 received by the transmission/reception section 24.

A display controller 26 generates map image data necessary for display on a display device 32 based on the map data stored in the map information memory 14. The display controller 26 generates, by three-dimensional image processing, data about a stereograph of the user's vehicle 4-1, which stereograph is a diagram viewed from a view point which is located at a predetermined height on the rear side of the vehicle.

A video RAM 27 temporarily stores therein the map image data and stereograph data generated by the display controller 26. That is, the map image data and stereograph data generated by the display controller 26 are temporarily stored in the video RAM 27, and one screenful of the map image data or the stereograph data is read from the RAM to be supplied to an image synthesizer 31.

A menu generating section 28 generates and supplies an image of menus required to perform various operations using the remote controller 15. A guidance route generating section 29 generates data about the guidance route using results provided by the guidance-route search processing program stored in the guidance route memory 20. That is, one or more pieces of data about a map area drawn in the video RAM 27 at the moment are selectively read from among the pieces of guidance route data stored in the guidance route memory 20, and then the guidance route is drawn by a thick highlighted line in a predetermined color, superimposed on the map image.

A mark generating section 30 generates and supplies a vehicle position mark which is to be displayed at a position of the user's vehicle 4-1 after the map matching processing, various landmarks which include a gas station and a convenience store etc., other vehicle position marks which are to be displayed at the positions of the other vehicles 4-2 and 4-3, and the like. The vehicle position marks of the vehicles 4-2 and 4-3 are made by reading necessary information from the vehicle image memory 23 and the another-vehicle-information memory 25 by the CPU 17. That is, characteristics information about the type and color of the vehicles 4-2 and 4-3 or the like is read from the another-vehicle-information memory 25, and vehicle image data corresponding to the characteristics information is read from the vehicle image memory 23 so as to generate the vehicle position marks to be displayed at the positions of the vehicles 4-2 and 4-3.

Note that the map matching processing involves matching the traveling position of the user's vehicle 4-1 with a position on a virtual road included in the map data by use of the map data read from the map information memory 14, the data about the position and traveling direction of the vehicle 4-1 measured by the GPS receiver of the position measuring device 13, and the data about an estimated position and direction of the vehicle detected by the autonomous navigation sensor.

The above-mentioned image synthesizer 31 synthesizes and produces various images. That is, when the two-dimensional display is selected with the remote controller 15, image synthesis is performed to superimpose the respective image data supplied by the menu generating section 28, the guidance route generating section 29 and the mark generating section 30 on the map image data read by the display controller 26, so that the synthesized image data is supplied to the display device 32. When the three-dimensional display is selected with the remote controller 15, image synthesis is performed to superimpose the respective image data supplied by the menu generating section 28, the guidance route generating section 29 and the mark generating section 30 on the stereograph data read by the display controller 26, so that the synthesized image data is supplied to the display device 32.

With this arrangement, map information about the user's vehicle position and its surroundings is displayed on the screen of the display device 32 together with the vehicle position marks of the user's and other vehicles. FIG. 2 shows an example of a three-dimensional display performed when the user's vehicle 4-1 is approaching a guidance intersection, in which the vehicle position marks of the vehicle 4-1 and the first other vehicle 4-2 are displayed on a three-dimensional map. It should be noted that the map screen for the intersection guidance can be used not only for the three-dimensional display but also for the two-dimensional display.

A voice generating section 33 generates voice for the intersection guidance and voice for various kinds of operational guidance. A speaker 34 outputs voice generated by the voice generating section 33. A bus 35 is used for transmission and reception of data among the above-mentioned functional components.

The above-mentioned CPU 17 determines whether or not the other vehicles 4-2 and 4-3 are traveling on the guidance route for the user's vehicle 4-1 and are located within a predetermined distance from the guidance intersection, based on the GPS information about the vehicles 4-2 and 4-3 stored in the another-vehicle-information memory 25 in accordance with the another-vehicle-extraction program stored in the ROM 18. When this condition is satisfied, the CPU 17 instructs the voice generating section 33 to produce the voice guidance, and the speaker 34 provides the voice guidance therefrom in accordance with the intersection guidance program stored in the ROM 18. In determining whether the condition is satisfied or not, data about the guidance routes for the other vehicles 4-2 and 4-3 stored in the another-vehicle-information memory 25 is also used.

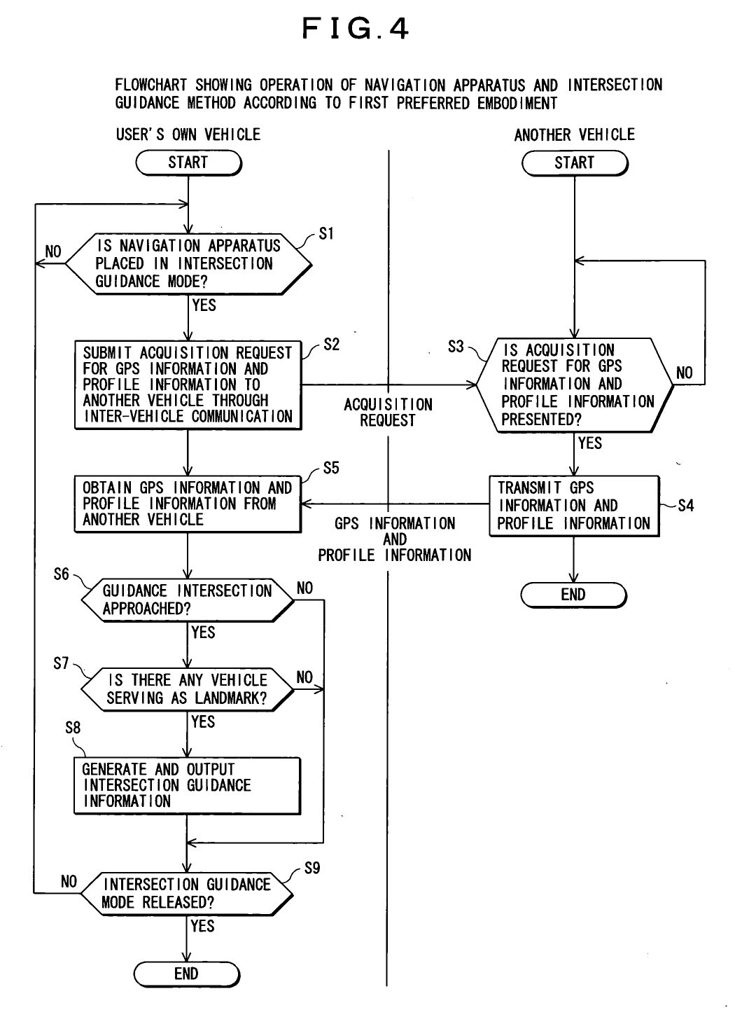

Now, an operation of the navigation apparatus 1-1 to 1-3 with the arrangement as described above and processes of an intersection guidance method will be described below in detail. FIG. 4 is a flowchart showing an operation of the navigation apparatus and an intersection guidance method according to the first preferred embodiment.

Referring to FIG. 4, first, the CPU 17 of the user's vehicle 4-1 determines whether or not the navigation apparatus is placed in an intersection guidance mode (step S1). If the apparatus is not placed in the guidance mode (If NO at step S1), processing of step S1 is repeated. In contrast, if the apparatus is placed in the guidance mode (If YES at step S1), the CPU 17 of the navigation apparatus 1-1 in the vehicle 4-1 submits an acquisition request for the GPS information and profile information about other vehicles through inter-vehicle communication with other vehicles located within a predetermined distance from the position of the vehicle 4-1 using the transmission/reception section 24 (step S2).

On the other hand, each of the other vehicles determines whether the acquisition request for the GPS and profile information transmitted from the user's vehicle 4-1 is received or not (step S3). If the acquisition request is presented from the vehicle 4-1 (If YES at step S3), the GPS and profile information about the other vehicle is transmitted therefrom to the vehicle 4-1 (step S4). If the acquisition request for the GPS and profile information is not received from the vehicle 4-1 (If NO at step S3), the processing of step S3 is repeated.

The user's vehicle 4-1 obtains the GPS and profile information from the other vehicles (step S5). While the vehicle 4-1 is traveling on the guidance route, it is determined whether or not the vehicle is approaching a guidance intersection to turn right or left (step S6). When the distance from the position of the vehicle 4-1 to the guidance intersection is equal to or less than a predetermined distance (e.g., 50 m), the vehicle 4-1 is determined to be approaching the guidance intersection.

If the user's vehicle 4-1 is not determined to be approaching the guidance intersection (If NO at step S6), the operation jumps to the processing at step S9. If the vehicle 4-1 is determined to be approaching the guidance intersection (If YES at step S6), the CPU 17 identifies the other vehicles 4-2 and 4-3 serving as the landmarks in accordance with the another-vehicle-extraction program stored in the ROM 18 (step S7).

At step S7, a method for extracting the other vehicles 4-2 and 4-3 serving as the landmarks involves, for example, specifying the other vehicles 4-2 and 4-3 which satisfy a predetermined condition by the CPU 17 based on the GPS information about the other vehicles obtained through the inter-vehicle communication between the user's vehicle 4-1 and other vehicles, and extracting profile information about the specified vehicles 4-2 and 4-3. The predetermined condition is that another vehicle is traveling on the guidance route for the vehicle 4-1 and located within a predetermined distance from the guidance intersection.

If no vehicle serving as a landmark like the other vehicle 4-2 or 4-3 is located (If NO at step S7), the operation jumps to the processing of step S9. In contrast, if there are some vehicles 4-2, 4-3 serving as the landmark (if YES at step S7), in the navigation apparatus 1-1 of the user's vehicle 4-1 the CPU 17 generates intersection guidance information based on the profile information about the other vehicles 4-2 and 4-3 in accordance with the intersection guidance program stored in the ROM 18. The voice generating section 33 generates voice corresponding to the generated intersection guidance information, and provides it from the speaker 34 (step S8). Thereafter, the CPU 17 determines whether the intersection guidance mode is released or not (step S9). If the intersection guidance mode is released (If YES at step S9), the operation is terminated. If the intersection guidance mode is not released (If NO at step S9), the operation returns to the processing at step S1.

As set forth in detail, according to the first preferred embodiment, while the user's vehicle 4-1 is traveling on the guidance route, the vehicle 4-1 establishes inter-vehicle communications with other vehicles located within a predetermined distance from the vehicle 4-1. When the vehicle 4-1 is approaching a guidance intersection to turn right or left, the vehicle 4-1 specifies from the respective GPS information the first other vehicle 4-2 that is traveling towards the guidance intersection in the direction opposite to the travel direction of the vehicle 4-1 on the guidance route for the vehicle 4-1 and/or the second other vehicle 4-3 that is traveling towards the guidance intersection in front of the vehicle 4-1 in the same direction as that of the vehicle 4-1 on the guidance route for the vehicle 4-1. Then, the navigation apparatus regards the specified other vehicles as landmarks.

The direction in which the user's vehicle 4-1 is to travel at the guidance intersection is shown or provided in relationship to the profile information about (the type or color of) the other vehicles 4-2 and 4-3. Even if no facility serving as a landmark is located in the surrounding area of the guidance intersection, or even if a facility located in the vicinity of the guidance intersection and serving as a landmark is difficult to observe because of its location, the vehicle 4-1 can provide the user with guidance on the guidance route in an easy-to-understand manner. Accordingly, this enables the user to easily identify the guidance intersection on the guidance route and to travel the guidance route without hesitation and without fail.

### Second Preferred Embodiment

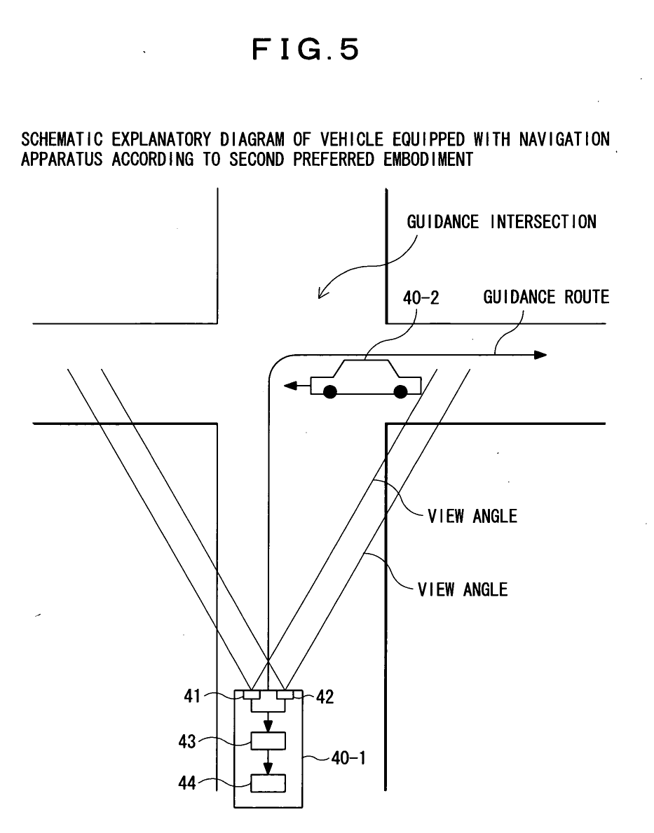

Now, a second preferred embodiment of the invention will be described below with reference to the accompanying drawings. FIG. 5 is a schematic explanatory diagram of a vehicle equipped with a navigation apparatus according to the second preferred embodiment. FIG. 5 shows that a user's vehicle 40-1 is traveling toward a guidance intersection on a guidance route. Another vehicle 40-2 is traveling toward the guidance intersection on the guidance route for the vehicle 40-1 in a direction opposite to the direction in which the vehicle 40-1 is to travel.

A first camera 41 is mounted on the left side of the front of the user's vehicle 40-1 facing forward, and a second camera 42 is mounted on the right side of the front of the user's vehicle facing forward. The first and second cameras 41 and 42 have respective predetermined viewing angles, and respective lens thereof are horizontally arranged in parallel with each other. The first and second cameras 41 and 42 are continuously photographing images of an area in front of the vehicle 40-1. A calculator 43 extracts an image part of the other vehicle 40-2 from the images photographed by the first and second cameras 41 and 42 by identification of the image, thereby obtaining a distance from the position of the vehicle 40-1 to the intersection which the other vehicle 40-2 is entering.

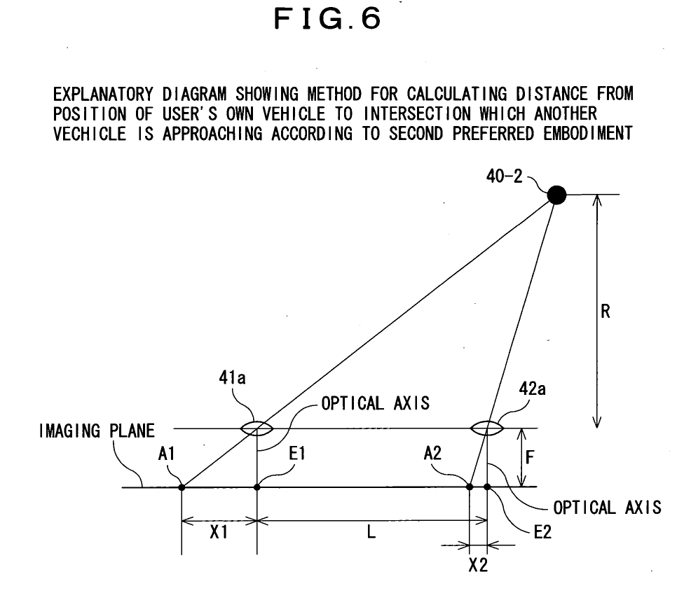

More specifically, as shown in FIG. 6, a reference point E1 is set at the position where an optical axis extending through the center of the lens 41a of the first camera 41 and an imaging plane with the photographed image formed thereon intersect with each other. An image-forming point A1 is set at the position where an image of the other vehicle 40-2 is actually formed. The amount of deviation (the amount of image shift) from the reference point E1 to the image-forming point A1 is set to a value X1. A reference point E2 is set at the position where an optical axis extending through the center of the lens 42a of the second camera 42 and an imaging plane with the photographed image formed thereon intersect with each other. An image-forming point A2 is set at the position where an image of the vehicle 40-2 is actually formed. The amount of deviation from the reference point E2 to the image-forming point A2 is set to a value X2. The amount of parallax X between the first and second cameras 41 and 42 can be obtained by the following equation (1).
X=X1−X2 (1)

When a distance between the reference points E1 and E2 is set to a value L and a focal distance of each of the lenses 41a and 42a is set to a value F, a distance R between the position of the user's vehicle 40-1 and the intersection which another vehicle 40-2 is entering can be obtained by the following equation (2).
R=F·L/X (2)

Not only the obtained distance R between the user's vehicle 40-1 position and the intersection being entered by the other vehicle 40-2, but also the images photographed by the cameras 41 and 42 are entered into a navigation apparatus 44. The navigation apparatus 44 obtains the traveling position information about the other vehicle 40-2 from the distance R, and the traveling direction information about the vehicle 40-2 from changes in images of the vehicle 40-2 photographed with the cameras 41 and 42. This determines whether or not the other vehicle 40-2 is traveling toward the guidance intersection on the guidance route for the vehicle 40-1 in the direction opposite to the direction of travel of the vehicle 40-1. The navigation apparatus 44 performs image analysis on the image part of the vehicle 40-2, thereby obtaining characteristics information concerning the type, category (e.g. van, sedan, wagon, or the like), and color of the vehicle 40-2.

The navigation apparatus 44 reads map data corresponding to the detected position of the user's vehicle 40-1 from the recording medium and displays it on the screen. Further, in addition to the position of the vehicle 40-1, the vehicle position mark of the other vehicle 40-2 is displayed on the map screen based on the information about the traveling position and traveling direction of the vehicle 40-2 and the characteristics information thereof. In the navigation apparatus 44, intersection guidance is provided with the other vehicle 40-2 serving as a landmark. Note that an intersection guiding method in the second embodiment is the same as in the first embodiment.

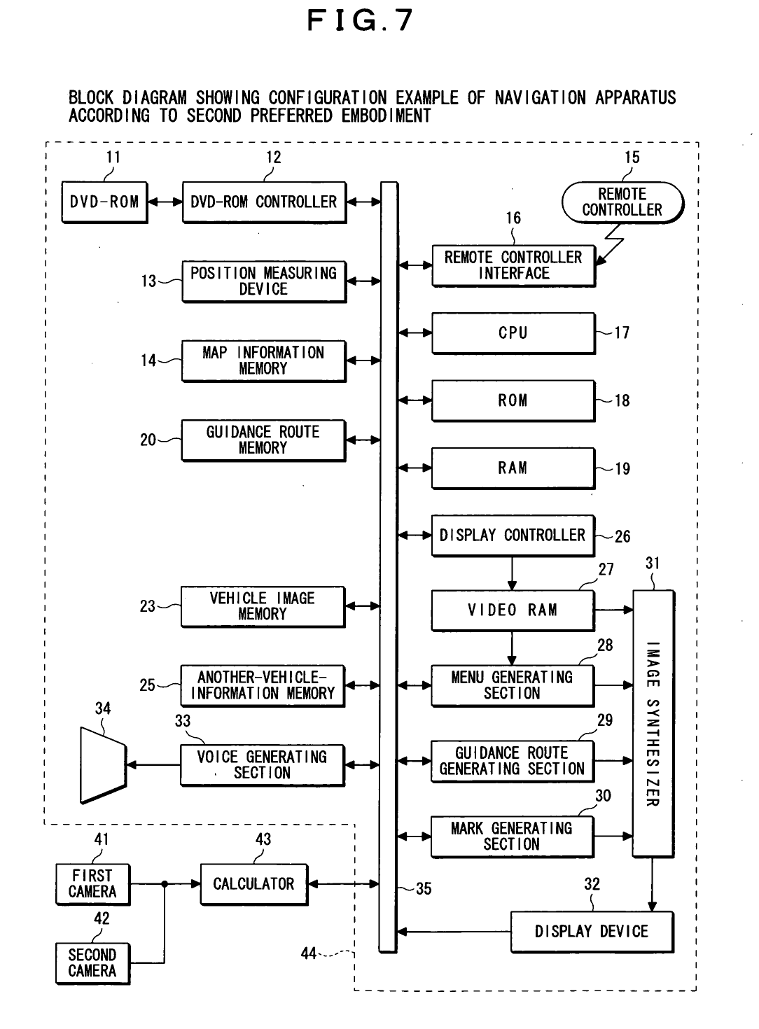

FIG. 7 is a block diagram showing an example of the overall configuration of the navigation apparatus 44 of the second preferred embodiment. Referring to the figure, components that are in common to FIG. 3 are given the same reference characters, and explanation thereof will be partially omitted hereinafter. In FIG. 7, the first camera 41, the second camera 42, and a calculator 43 are used to calculate a distance R from the position of the user's vehicle 40-1 to the intersection which the other vehicle 40-2 is entering, based on the foregoing equation (2). The CPU 17 obtains the information about the traveling position of the other vehicle 40-2 from the distance R calculated by the calculator 43, and then stores it in the another-vehicle-information memory 25.

The images of the other vehicle 40-2 photographed by the cameras 41 and 42 are stored in the another-vehicle-information memory 25. The CPU 17 compares the images of the vehicle 40-2 stored in the another-vehicle-information memory 25 with image data about diverse types and colors of various vehicles, which data is stored in the vehicle image memory 23, thereby obtaining the characteristics information about the type, category (e.g., van, sedan, or wagon), and color of the other vehicle 40-2 to store it in the another-vehicle-information memory 25. In addition, the traveling direction information about the vehicle 40-2 is obtained from changes in the images of the vehicle 40-2 photographed by the cameras 41 and 42 and stored in the another-vehicle-information memory 25.

The CPU 17 determines whether or not the other vehicle 40-2 is traveling on the guidance route for the user's vehicle 40-1 and located within the predetermined distance from the guidance intersection, based on the information about the traveling position and direction of the vehicle 40-2, which information is stored in the another-vehicle-information memory 25, in accordance with the another-vehicle-extraction program stored in the ROM 18. When this condition is satisfied, the CPU 17 commands the voice generating section 33 to provide voice guidance in accordance with the intersection guidance program stored in the ROM 18, so that the voice guidance is produced from the speaker 34.

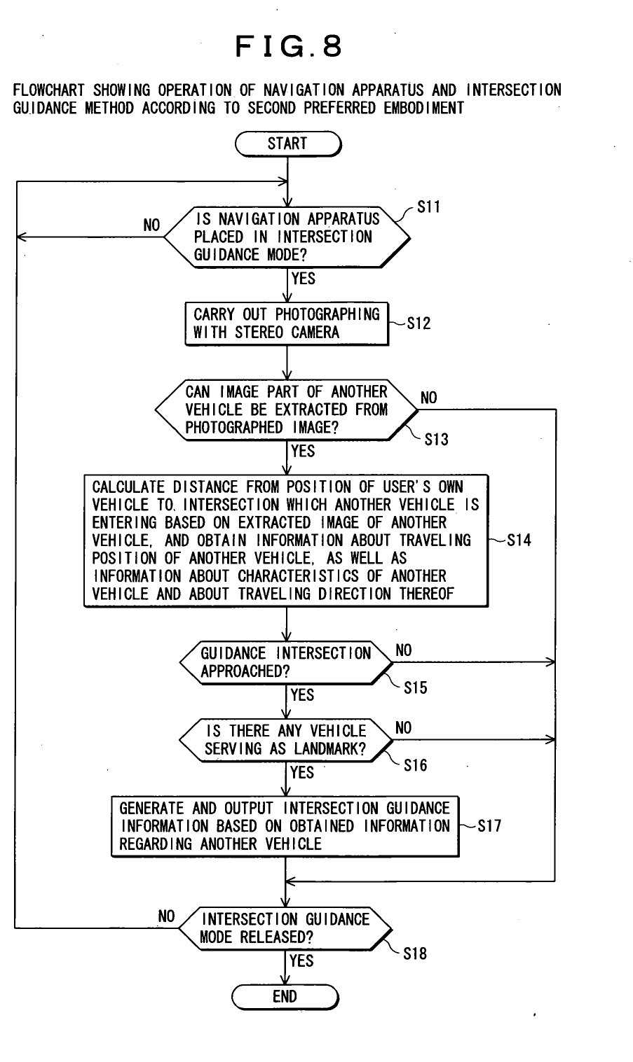

Now, an operation of the navigation apparatus 44 with the arrangement as described above and processes of an intersection guidance method using same will be described below in detail. FIG. 8 is a flowchart showing an operation of the navigation apparatus and an intersection guidance method according to the second preferred embodiment.

Referring to FIG. 8, first, the CPU 17 of the user's vehicle 40-1 determines whether or not the navigation apparatus is placed in an intersection guidance mode (step S11). If the apparatus is not placed in the intersection guidance mode (If NO at step S11), the processing of step S11 is repeated. In contrast, if the apparatus is placed in the intersection guidance mode (If YES at step S11), an area located in front of the vehicle 40-1 is photographed with the first and second cameras 41 and 42 mounted on the vehicle 40-1 (step S12). Then, identifying the photographed image determines whether the image part of the other vehicle 40-2 can be extracted or not (step S13).

When the identification of the photographed image fails to extract the image part of the other vehicle 40-2 (If NO at step S13), the operation jumps to step S18. In contrast, if the image part of the vehicle 40-2 is extracted (If YES at step S13), the distance R from the position of the user's vehicle 40-1 to the intersection being entered by the vehicle 40-2 is obtained with the calculator 43, based on the images of the vehicle 40-2 photographed by the first and second cameras 41 and 42, using the foregoing equations (1) and (2). The CPU 17 obtains the traveling position information about the other vehicle 40-2 from the obtained distance R to store it in the another-vehicle-information memory 25. The image analysis is performed on the images of the vehicle 40-2 to obtain the characteristics information about the vehicle 40-2 and to store it in the memory 25, while obtaining the traveling direction information about the vehicle 40-2 from changes in the images of the other vehicle 40-2 to store it in the memory 25 (step S14).

Then, the CPU 17 determines whether the user's vehicle 40-1 is approaching a guidance intersection to turn right or left while traveling on the guidance route (step S15). When a distance from the position of the vehicle 40-1 to the guidance intersection is equal to or less than a specified distance (for example, 50 m), the vehicle 40-1 is determined to be approaching the guidance intersection.

If the user's vehicle 40-1 is not determined to be approaching the guidance intersection (If NO at step S15), the operation jumps to step S18. In contrast, if the vehicle 40-1 is determined to be approaching the guidance intersection (if YES at step S15), the CPU 17 compares the information about the traveling position and direction of the other vehicle 40-2 stored in the another-vehicle-information memory 25 with the map data so as to determine whether there is any vehicle 40-2 serving as the landmark and located near the guidance intersection (step S16).

If there is no vehicle 40-2 serving as the landmark (If NO at step S16), the operation jumps to step S18. In contrast, if the other vehicle 40-2 serves as the landmark (if YES at step S16), the CPU 17 generates the intersection guidance information based on the characteristics information of the vehicle 40-2 stored in the another-vehicle-information memory 25 in accordance with the intersection guidance program stored in the ROM 18. The voice generating section 33 generates guidance voice corresponding to the intersection guidance information, so that the generated guidance voice is produced from the speaker 34 (step S17).

Then, the CPU 17 determines whether the intersection guidance mode is released or not (step S18). If the intersection guidance mode is released (If YES at step S18), the operation is terminated. If the intersection guidance mode is not released (If NO at step S18), the operation returns to step S11.

As will be seen from the above description, according to the second preferred embodiment, the user's vehicle 40-1 photographs the area in front of the vehicle with the first and second cameras 41 and 42 while traveling on the guidance route. When the vehicle 40-1 approaches a guidance intersection to turn right or left, the vehicle 40-1 extracts from the photographed image an image part of the other vehicle 40-2 that is traveling toward the guidance intersection on the guidance route for the vehicle 40-1 in the direction opposite to the travel direction of the vehicle 40-1. Alternatively, the vehicle 40-1 extracts from the photographed image an image part of the other vehicle that is traveling in front of the vehicle 40-1 toward the guidance intersection on the guidance route for the vehicle 40-1 in the same direction as that of the vehicle 40-1 so as to set the other vehicle as the landmark.

The travel direction of the user's vehicle 40-1 at the guidance intersection is presented to the user in relation to the characteristics information (the type and color) of the other vehicle 40-2 specified from the photographed image part. Accordingly, when there is no facility located around the guidance intersection and serving as a landmark or otherwise when a facility located around the guidance intersection and serving as the landmark is difficult to observe because of its location, the vehicle 40-1 can guide the user through the guidance intersection on the guidance route in an easy-to-understand manner. This permits the user to easily identify or observe the guidance intersection on the guidance route, and hence to adequately travel on the guidance route without hesitation and without fail.

It should be noted that although the user's vehicle 4-1 establishes the inter-vehicle communications with the other vehicles 4-2 and 4-3 to directly obtain the GPS and profile information thereof in the first embodiment, the invention is not limited thereto. For example, a communication device for establishing communication between a road and a vehicle may be disposed near the guidance intersection or the like, through which device the vehicle 4-1 may be configured to communicate with the other vehicles 4-2 and 4-3.

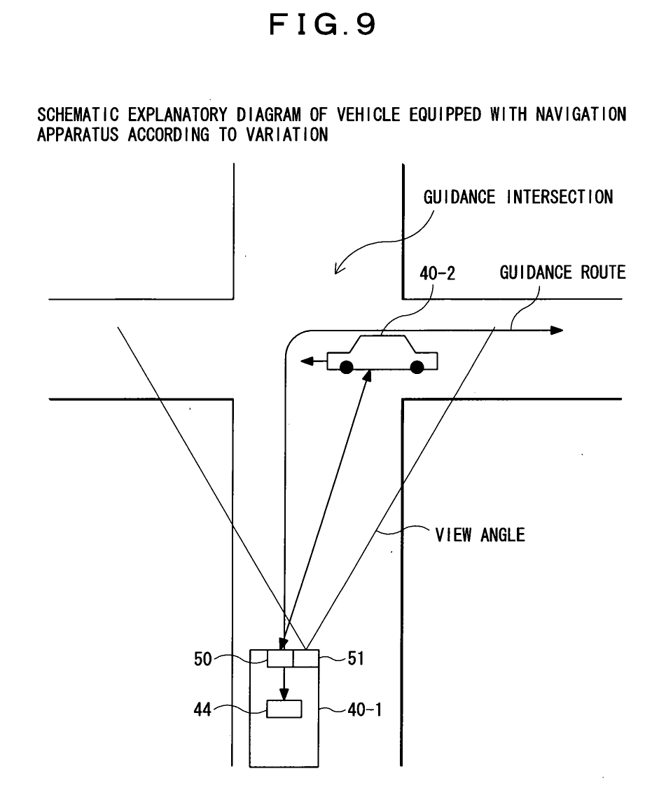

In the first embodiment, the user's vehicle 4-1 utilizes the inter-vehicle communication to obtain the GPS and profile information about the other vehicles 4-2 and 4-3, while in the second embodiment the vehicle 40-1 utilizes stereo cameras to obtain the traveling position and direction information and the characteristics information about the other vehicle 40-2, but the invention is not limited thereto. For example, as shown in FIG. 9, radar 50 with millimeter wave or infrared rays may be used to obtain the traveling position and direction information about the other vehicle 40-2. Alternatively or additionally, the camera 51 may be used to obtain the characteristics information and the traveling direction information about the other vehicle 40-2 from the photographed images thereof. Moreover, the use of the combination of the camera and radar in the above-mentioned inter-vehicle communication may obtain information about other vehicles.

Although in the first embodiment, the user's vehicle 4-1 uses inter-vehicle communication to obtain the GPS information from the other vehicles 4-2 and 4-3, thereby obtaining the traveling position and direction information thereof, the invention is not limited thereto. For example, instead of the GPS information, information from autonomous navigation sensors of the vehicles 4-2 and 4-3 may be used to obtain the traveling position and direction information about them. Alternatively, the combination of the GPS information and the information from the autonomous navigation sensor may be used to obtain the traveling position and direction information about the other vehicles 4-2 and 4-3.

Although in the first and second embodiments, the predetermined condition is based on whether or not the other vehicle 4-2, 4-3 or 40-2 is traveling on the guidance route for the user's vehicle 4-1 or 40-1 and is located within the predetermined distance from the guidance intersection, the invention is not limited thereto. For example, the predetermined condition may be based on whether another vehicle is entering the guidance intersection or not. Therefore, when the vehicle 4-1 or 40-1 is traveling on a guidance route which leads the vehicle to turn right, another vehicle entering the intersection facing the vehicle 4-1 or 40-1 or entering the intersection from the left with respect to the vehicle 4-1 or 40-1 may be regarded as one which meets the predetermined condition.

Although in the first and second embodiments the GPS information is used as the information concerning the traveling position and direction of the vehicle, the invention is not limited thereto. For example, instead of the GPS information, information provided by the autonomous navigation sensor, or a combination of the GPS information and information obtained by the autonomous sensor may be used.

In the first and second preferred embodiments, in the case of displaying the other vehicle 4-2, 4-3 or 40-2 on the map screen, the vehicle 4-2, 4-3 or 40-2 may be constantly displayed. Alternatively, the vehicle 4-2, 4-3 or 40-2 may be displayed only when the user's vehicle 4-1 or 40-1 is approaching the guidance intersection. Otherwise, only when the vehicle 4-1 or 40-1 is approaching the guidance intersection and no facility or traffic signal serving as a landmark is located at the guidance intersection, the other vehicle 4-2, 4-3 or 40-2 may be displayed.

In the first and second embodiments, in the case of intersection guidance using the vehicles 4-2, 4-3 and 40-2 as the landmarks, that is, when the vehicles 4-2, 4-3 and 40-2 serving as the landmarks exist, the intersection guidance may be constantly carried out. Alternatively, only when there is no facility or traffic signal serving as the landmark, the intersection guidance may be carried out.

In the first and second embodiments, the other vehicle 4-2, 4-3 or 40-2 may be used as the landmark only when its speed is equal to or less than a predetermined value. Since other vehicles entering the guidance intersection at high speeds do not act as landmarks, this allows the user to easily identify the other vehicle 4-2 or 4-3 serving as the landmark.

In the first embodiment, when there are a plurality of other vehicles such as the first other vehicle 4-2 that is traveling toward the guidance intersection on the guidance route for the user's vehicle 4-1 in the direction opposite to the travel direction of the vehicle 4-1, only the leading other vehicle 4-2 among them may be used as the landmark. This can restrict the landmark to the single vehicle 4-2, thereby simplifying the intersection guidance. Likewise, when there are a plurality of vehicles such as the second other vehicle 4-3 that is traveling in front of the vehicle 4-1 toward the guidance intersection on the guidance route for the vehicle 4-1 in the same direction as the vehicle 4-1, only the nearest vehicle 4-3 from the vehicle 4-1 may be used as the landmark. This can restrict the landmark to the single vehicle 4-3, thereby simplifying the intersection guidance.

Although, in the second embodiment, the intersection guidance involving showing the user the category of vehicle is performed based on the premise that the entire other vehicle 40-2 is photographed so that its shape can be identified, the invention is not limited thereto. For example, when only part of the vehicle such as the front part of the other vehicle 40-2 has been photographed, the intersection guidance may be performed based on only the color of the vehicle and not the category of the vehicle. This enables adequate intersection guidance even when the characteristics information about the other vehicle 40-2 is not obtained completely.

In the second embodiment, a camera capable of photographing at night, such as an infrared camera, may be used in photographing the other vehicle 40-2. In this case, since the color of the vehicle cannot be identified, the intersection guidance is performed based on only the category of the vehicle. This enables intersection guidance even when the characteristics information of the other vehicle 40-2 is not obtained completely.

It is understood that both the above-mentioned first and second preferred embodiments are merely illustrative so as to exploit the invention and should not limit the technical scope of the invention. That is, it should be apparent to those skilled in the art that the present invention may be embodied in many other specific forms without departing from the spirit or scope of the invention.

The invention is useful for the vehicle navigation apparatus which shows the user the direction of travel at a guidance intersection on the guidance route using a landmark.

1. A navigation apparatus comprising:
an another-vehicle-information obtaining section for obtaining information regarding another vehicle located in the vicinity of a user's vehicle from said another vehicle when the user's vehicle is approaching within a specified distance from an intersection for guidance on a guidance route;
a controller for determining whether or not a predetermined condition is satisfied based on the information regarding said another vehicle obtained by said another-vehicle-information obtaining section; and
a guidance section for providing a guidance message indicating a direction in which the user's vehicle is to travel in relation to said another vehicle when said controller determines that the predetermined condition is satisfied.

2. The navigation apparatus according to claim 1, further comprising a vehicle image memory for storing therein image data corresponding to a vehicle, wherein said controller is adapted to display a mark indicative of a position of said another vehicle on a display device using the obtained information regarding said another vehicle.

3. The navigation apparatus according to claim 1, wherein said another-vehicle-information obtaining section obtains information about characteristics of said another vehicle, information about a traveling position thereof, and information about a traveling direction thereof, as information regarding said another vehicle.

4. The navigation apparatus according to claim 3, wherein said another-vehicle-information obtaining section obtains the information regarding said another vehicle by establishing communications with said another vehicle.

5. The navigation apparatus according to claim 3, wherein said another-vehicle-information obtaining section obtains the information regarding said another vehicle by photographing said another vehicle.

6. The navigation apparatus according to claim 3, wherein said controller determines whether or not said another vehicle is approaching within a predetermined distance from the guidance intersection based on said information about the traveling position and said information about the traveling direction, and
wherein said guidance section provides the guidance message including the characteristics information about said another vehicle when the controller determines that said another vehicle is approaching within the predetermined distance from the guidance intersection.

7. The navigation apparatus according to claim 3, wherein said controller determines whether or not said another vehicle is traveling in a direction opposite to the travel direction of the user's vehicle on the guidance route, and whether or not said another vehicle is approaching within a predetermined distance from the guidance intersection, based on said information about the traveling position and said information about the traveling direction, and
wherein said guidance section provides the guidance message including the characteristics information about said another vehicle when the controller determines that said another vehicle is traveling in the direction opposite to the travel direction of the user's vehicle on the guidance route and is approaching within the predetermined distance from the guidance intersection.

8. The navigation apparatus according to claim 3, wherein said controller determines whether or not said another vehicle is traveling in front of the user's vehicle in the same direction as the user's vehicle on the guidance route, and whether or not said another vehicle is approaching within the predetermined distance from the guidance intersection, based on said information about the traveling position and said information about the traveling direction, and
wherein said guidance section provides the guidance message including the characteristics information about said another vehicle when the controller determines that said another vehicle is traveling in front of the user's vehicle in the same direction on the guidance route and is approaching within the predetermined distance from the guidance intersection.

9. A navigation apparatus comprising:
an another-vehicle-information obtaining section for obtaining as information regarding another vehicle located in the vicinity of a user's vehicle from said another vehicle, information about characteristics of said another vehicle, information about a traveling position thereof, and information about a traveling direction thereof when the user's vehicle is approaching within a specified distance from an intersection for guidance on a guidance route;
a controller for determining whether or not said another vehicle is approaching within a predetermined distance from the guidance intersection based on said information about the traveling position and said information about the traveling direction; and
a guidance section for providing a guidance message including the characteristics information about said another vehicle when the controller determines that said another vehicle is approaching within the predetermined distance from the guidance intersection.

10. The navigation apparatus according to claim 9, further comprising a vehicle image memory for storing therein image data corresponding to a type and a color of the vehicle, wherein said controller is adapted to display a mark indicative of the position of said another vehicle on a display device using the obtained information regarding said another vehicle.

11. The navigation apparatus according to claim 9, wherein said another-vehicle-information obtaining section obtains the information regarding said another vehicle by establishing communications with said another vehicle.

12. The navigation apparatus according to claim 9, wherein said another-vehicle-information obtaining section obtains the information regarding said another vehicle by photographing said another vehicle.

13. An intersection guidance method for guiding a user's vehicle to an intersection, comprising:
obtaining information regarding another vehicle located within a predetermined distance from a position of a user's vehicle;
determining whether or not the user's vehicle is approaching within a specified distance from an intersection for guidance on a guidance route;
determining whether or not said another vehicle satisfies a predetermined condition based on the obtained information regarding said another vehicle when the user's vehicle is determined to be approaching within the specified distance from the guidance intersection; and
providing a guidance message indicating a direction in which the user's vehicle is to travel in relation to the information regarding said another vehicle when said another vehicle is determined to satisfy the predetermined condition.

14. The intersection guidance method according to claim 13, further comprising displaying a mark indicative of a position of said another vehicle on a display device using the obtained information regarding said another vehicle, wherein a vehicle image memory is further provided for storing therein image data corresponding to a vehicle.

15. The intersection guidance method according to claim 13, wherein said information regarding the another vehicle includes information about characteristics of said another vehicle, information about a traveling position thereof, and information about a traveling direction thereof,
wherein, whether or not said another vehicle is traveling on the guidance route for the user's vehicle and whether or not said another vehicle is approaching within a predetermined distance from the guidance intersection are determined based on said information about the traveling position and said information about the traveling direction, and
wherein, when the another vehicle is determined to be traveling on the guidance route for the user's vehicle and to be approaching within the predetermined distance from the guidance intersection, the guidance message indicating the travel direction of the user's vehicle is provided in relation to the information regarding said another vehicle.

16. An intersection guidance method for guiding a user's vehicle to an intersection, comprising:
photographing an area located in front of a user's vehicle over a predetermined range;
extracting an image portion of another vehicle from a photographed image by identification of the image to obtain information regarding said another vehicle;
determining whether or not the user's vehicle is approaching within a specified distance from an intersection for guidance on a guidance route;
determining whether or not said another vehicle satisfies a predetermined condition based on the obtained information regarding said another vehicle when the user's vehicle is determined to be approaching within the specified distance from the guidance intersection; and
providing a guidance message indicating a direction in which the user's vehicle is to travel in relation to the information regarding said another vehicle when said another vehicle is determined to satisfy said predetermined condition.

17. The intersection guidance method according to claim 16, wherein the obtained information regarding said another vehicle includes information about a distance from a position of the user's vehicle to an intersection which said another vehicle is entering.

18. The intersection guidance method according to claim 16, wherein said predetermined condition is based on whether the intersection which said another vehicle is entering is the guidance intersection or not.

19. The intersection guidance method according to claim 16, wherein the information about said another vehicle provided in the guidance message includes characteristics information based on the image of said another vehicle.

20. An intersection guidance method for guiding a user's vehicle to an intersection, comprising:
photographing an area located in front of a user's vehicle over a predetermined range;
extracting an image portion of another vehicle from a photographed image by identification of the image;
determining a distance from a position of the user's vehicle to an intersection which said another vehicle is entering based on the image of said another vehicle;
determining whether or not the user's vehicle is approaching within a specified distance from an intersection for guidance on a guidance route;
determining whether or not the intersection which said another vehicle is entering is the guidance intersection, based on the distance from the user's vehicle position to the intersection being entered by said another vehicle, when the user's vehicle is determined to be approaching within the specified distance from the guidance intersection; and
providing a guidance message indicating a direction in which the user's vehicle is to travel in relation to characteristics information based on the image of said another vehicle when the intersection which said another vehicle is entering is determined to be the guidance intersection.
